(19) United States
(12) Patent Application Publication
(10) Pub. No.: US 2026/0025075 A1
(43) Pub. Date: Jan. 22, 2026

(54) FLYBACK POWER CONVERTER PRIMARY SIDE CONTROLLER AND METHODS OF OPERATING THE SAME

(71) Applicant: Navitas Semiconductor Limited, Dublin (IE)

(72) Inventor: Chien-Chun HUANG, Taoyuan City (TW)

(73) Assignee: Navitas Semiconductor Limited, Dublin (IE)

(21) Appl. No.: 19/270,094

(22) Filed: Jul. 15, 2025

Related U.S. Application Data
(60) Provisional application No. 63/672,142, filed on Jul. 16, 2024.

(51) Int. Cl. H02M 3/335

(52) U.S. Cl. CPC H02M 3/33507

(57) ABSTRACT

A circuit is disclosed. The circuit includes a solid state switch controlled by a control circuit, the control circuit arranged to transition the solid state switch from a first on-state to a first off-state, where in response to the transition a plurality of resonant voltage valleys occur at a drain terminal of the solid state switch, the control circuit further arranged to: determine an input power to the power converter circuit and in response, determine a resonant voltage valley number based at least in part on the input power, and transition the solid state switch from the first off-state to a second on-state when a sequential number of the plurality of resonant voltage valleys equals the resonant voltage valley number.

### CROSS-REFERENCES TO OTHER APPLICATIONS

This application claims priority to U.S. patent application Ser. No. 63/672,142, for “FLYBACK POWER CONVERTER PRIMARY SIDE CONTROLLER AND METHODS OF OPERATING THE SAME,” filed on Jul. 16, 2024, which is hereby incorporated by reference in its entirety for all purposes.

### FIELD

The described embodiments relate generally to power converters, and more particularly, the present embodiments relate to a flyback power converter primary side controller and methods of operating the same.

### BACKGROUND

Electronic devices such as computers, servers and televisions, among others, employ one or more electrical power conversion circuits to convert one form of electrical energy to another. Some electrical power conversion circuits convert a high (or low) DC voltage to a lower (or higher) DC voltage using a circuit topology called DC-DC converter. As many electronic devices are sensitive to size and efficiency of the power conversion circuit, new power converters can provide relatively higher efficiency and lower size for the new electronic devices.

### SUMMARY

In some embodiments, a circuit is disclosed. The circuit includes a transformer having a primary winding magnetically coupled to a secondary winding, the primary winding extending from a first terminal to a second terminal, the first terminal connected to a power source; a switch having a gate terminal, a source terminal and a drain terminal, the drain terminal connected to the second terminal, the source terminal coupled to a ground; and a controller circuit connected to the gate terminal and arranged to transition the switch from a first on-state to a first off-state, where in response to the transition a plurality of resonant voltage valleys occur at the drain terminal, the controller circuit further arranged to: determine an input power at the first terminal and in response, and determine a resonant voltage valley number based at least in part on the input power; and transition the switch from the first off-state to a second on-state when a sequential number of a plurality of resonant voltage valley numbers equals the resonant voltage valley number.

In some embodiments, the transition from the first off-state to the second on-state is performed after a predetermined period of time.

In some embodiments, the resonant voltage valley number is a first resonant voltage valley number, the controller circuit further arranged to determine a second resonant voltage valley number and transition the switch to a third on-state based at least in part on the second resonant voltage valley number.

In some embodiments, the transition to the third on-state is performed after the predetermined period of time.

In some embodiments, determining the resonant voltage valley number includes comparing the determined input power to a predetermined threshold value.

In some embodiments, the controller circuit includes a lookup table having a plurality of predetermined threshold values.

In some embodiments, determining the input power includes sensing an input voltage at the first terminal, sensing a current flowing through the drain terminal to the source terminal and calculating the input power based on the sensed input voltage and the sensed current.

In some embodiments, a power converter circuit is disclosed. The power converter circuit includes a solid state switch controlled by a control circuit, the control circuit arranged to transition the solid state switch from a first on-state to a first off-state, where in response to the transition a plurality of resonant voltage valleys occur at a drain terminal of the solid state switch, the control circuit further arranged to: determine an input power to the power converter circuit and in response, determine a resonant voltage valley number based at least in part on the input power; and transition the solid state switch from the first off-state to a second on-state when a sequential number of the plurality of resonant voltage valleys equals the resonant voltage valley number.

In some embodiments, a method of operating power converter circuit is disclosed. The method includes: providing a solid state switch in the power converter circuit; controlling the solid state switch, by a control circuit, to transition from a first on-state to a first off-state, where in response to the transition a plurality of resonant voltage valleys occur at a drain terminal of the solid state switch; determining, by the control circuit, an input power to the power converter circuit; determining a resonant voltage valley number, in response to determining the input power, based at least in part on the input power; and transitioning, by the control circuit, the solid state switch from the first off-state to a second on-state when a sequential number of the plurality of resonant voltage valleys equals the resonant voltage valley number.

In some embodiments, the predetermined period of time has a value of zero.

In some embodiments, the resonant voltage valley number is a first resonant voltage valley number, and the method further includes determining, by the control circuit, a second resonant voltage valley number and controlling the solid state switch to transition to a third on-state based at least in part on the second resonant voltage valley number.

In some embodiments, determining the resonant voltage valley number includes comparing the determined input power to a predetermined threshold value.

In some embodiments, determining the input power includes sensing an input voltage to the power converter circuit, sensing a current flowing through the drain terminal to a source terminal of the solid state switch and calculating the input power based on the sensed input voltage and the sensed current.

### BRIEF DESCRIPTION OF THE DRAWINGS

FIG. 1A illustrates a schematic of a quasi-resonant (QR) flyback converter circuit with a primary side controller, according to embodiments of the disclosure. FIG. 1B illustrates an operation of the main switch of the QR flyback converter of FIG. 1A;

FIG. 2 illustrates a diagram of a valley lock number selection based on input power, according to some embodiments of the disclosure;

FIG. 3 illustrates an example of a valley selection method used to select a valley number for operating the main switch of the QR flyback converter of FIG. 1A, according to certain embodiments;

FIG. 4 illustrates a graph for determining the valley number, according to embodiments of the disclosure;

FIG. 5 illustrates a schematic of a valley number selection and determination circuit that can be used to change the valley number, according to certain embodiments;

FIGS. 6A and 6B illustrates a power converter with circuits arranged to determine input power using input voltage sensing, according to certain embodiments. FIG. 6A illustrates a controller circuit that includes a primary side controller co-packaged along with a power switch.

FIG. 6B illustrates auxiliary voltage Vaux and the voltage at DMAG pin; and

FIG. 7 is a simplified flowchart illustrating a method of determining valley number in a QR flyback converter based on primary side input power, according to some embodiments of the disclosure.

### DETAILED DESCRIPTION

Circuits, devices and related techniques disclosed herein relate generally to power converters. More specifically, circuits, devices and related techniques disclosed herein relate to a flyback power converter primary side controller and methods of operating the same. In some embodiments, the input power delivered into a quasi-resonant (QR) flyback converter circuit can be monitored by the primary side controller and used to control a resonant voltage valley number for the switching of the main switch. In various embodiments, valley number switching can be performed after a predetermined time period. Embodiment of the disclosure enable a reduction of electromagnetic interference (EMI), thereby reducing audible noise. In some embodiments, the QR flyback converter may operate using resonant voltage valley switching to reduce switching losses of a main switch, where the input power can be used to determine which valley is to be used for switching.

In some embodiments, an input power lookup table on the primary side controller may be used to determine which resonant voltage valley to is to be used for the operation of the QR flyback converter. Circuits and related techniques disclosed herein can be used in various power converter circuits for efficient resonant voltage valley jumping. In some embodiments, circuits and techniques for updating valley number can minimize rapid valley number changes, thereby reducing audible noise. In various embodiments, a QR flyback converter's primary side controller's memory may include a lookup table having input power threshold values. The input power threshold values can be used to determine the resonant voltage valley used for operating the QR flyback converter. In some embodiments, an external adjustable component, such as, but not limited to, a resistor may be used to set the power threshold values. In some embodiments, when monitored input power remains in a new range for a debounce time, for example, 1 millisecond, the valley number is updated.

In various embodiments, a primary side controller can receive a first signal corresponding to input voltage of the QR flyback converter and receive a second signal corresponding to a current flowing through the primary side main switch. The primary side controller can calculate the input power based on the input voltage and the current flowing though the primary side main switch. Based on the calculated input power, the primary side controller can determine an operating switching valley. In this way, the primary side controller can operate in a feed forward mode that can be relatively fast in responding to changes of input voltage compared to the current approaches where feedback from the output voltage may be used to provide feedback to a primary side controller.

In some embodiments, disclosed QR flyback converters with primary side input power valley number may utilize gallium nitride (GaN) power switches and/or circuitry. In various embodiments, the disclosed QR flyback converters may utilize silicon-based or silicon carbide-based power switches and/or circuitry. Various inventive embodiments are described herein, including methods, processes, systems, devices, and the like.

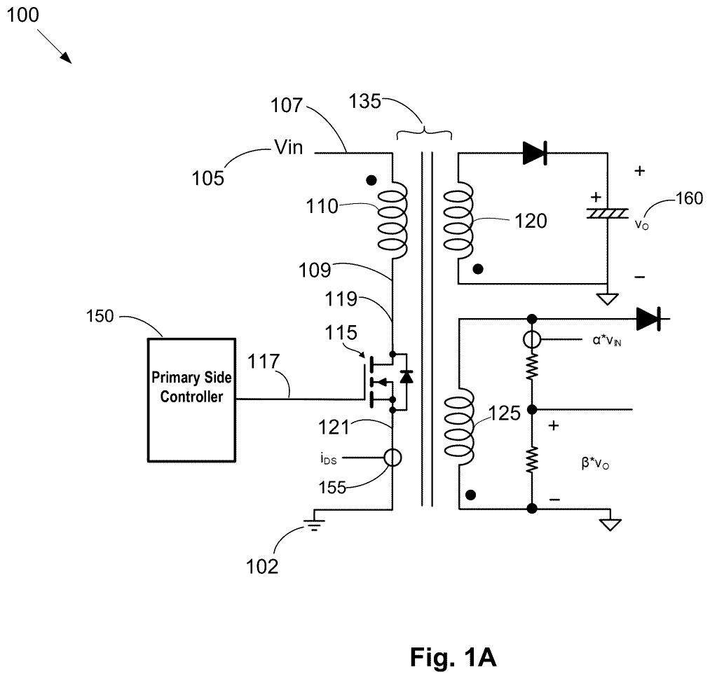

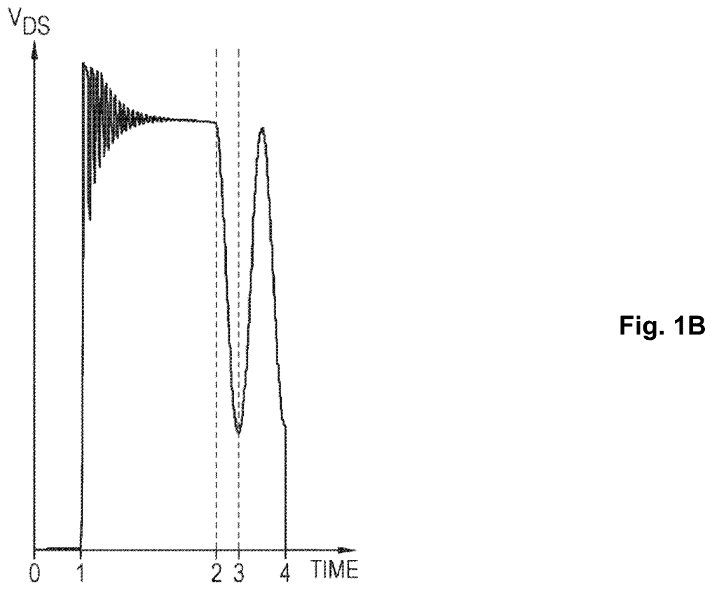

FIG. 1A illustrates a schematic of a QR flyback converter circuit with a primary side controller, according to embodiments of the disclosure. As shown in FIG. 1, a QR flyback converter circuit 100 may include a transformer 135 having a primary winding 110, a secondary winding 120 and an auxiliary winding 125. The secondary side winding 120 and the auxiliary winding 125 may each have an opposite winding direction to that of the primary winding 110. In some embodiments, the secondary side winding 120 and the auxiliary winding 125 may each have the same winding direction to that of the primary winding 110. The primary winding 110 can be magnetically coupled to a secondary winding 120, and to the auxiliary winding 125. The primary winding 110 can be extending from a first terminal 107 to a second terminal 109. The QR flyback converter circuit 100 may further include a switch 115 having a gate terminal 117, a drain terminal 119 and a source terminal 121. The drain terminal 119 can be connected to the second terminal 109. The source terminal 121 can be connected to a current sensing device 155. The current sensing device 155 can be connected a ground 102. The current sensing device 155 can be arranged to sense the drain-to-source current in the switch 115.

An input voltage 105 (VIN) may be applied to the primary winding 110 at the first terminal 107. The switch 115 may be gallium nitride (GaN) based, silicon-based or silicon carbide-based power switch. A primary side controller circuit 150 may be coupled to the switch 115 at the gate terminal 117. The primary side controller circuit 150 can be arranged to control a state of operation of the switch 115. The QR flyback converter circuit 100 can generate an output voltage 160 (vo) at the secondary side winding. The QR flyback converter circuit 100 can be arranged to operate using resonant voltage valley switching. The primary side controller circuit 150 can be arranged to determine an input power to the first terminal, compare the determined input power to a predetermined threshold, and control an operating valley number for the switch based on the result of the comparison and a predetermined time period. In some embodiments, the primary side controller circuit 150 can include a lookup table having a plurality of predetermined threshold values.

FIG. 1B illustrates an operation of the switch 115. FIG. 1B shows the drain-to-source voltage of switch 115. From time 0-1, the switch 115 may be on. At time 1, the switch may be turned off. Between 1-2, transformer 135 is releasing stored magnetic energy, such that at time 2 it is fully discharged which can lead to ringing behavior that occurs between times 2-4. From times 2 to 4, resonance observed between primary winding 110 and switch 115 can induce peaks and valleys in the drain-to source vDs of the switch 115. The QR flyback converter 100 can work more efficiently when the switch 115 is turned on at a valley instead of a peak. First valley (n=1) occurs at time 3. The switch 115 can be turned back on at time 4 at the second valley (n=2).

Circuits and techniques disclosed herein can be used to determine the valley number. In some embodiments, primary side controller circuit 150 can determined the valley number based on the input power to the primary side. The primary side controller 150 can calculate the input power based on the input voltage and the current through the switch 115. The current through the switch 115 can be sensed by the current sending device 155. The primary side controller circuit 150 can compare the calculated input power to a power threshold value that is stored in a lookup table stored in a memory of the primary side controller circuit 150. Based on the results of the comparison and a predetermined time period, the primary side controller circuit 150 can adjust the operating valley number in order to have an efficient operation to reduce losses and to minimize emitted EMI and audible noise. In some embodiments, the predetermined period of time has a value of zero.

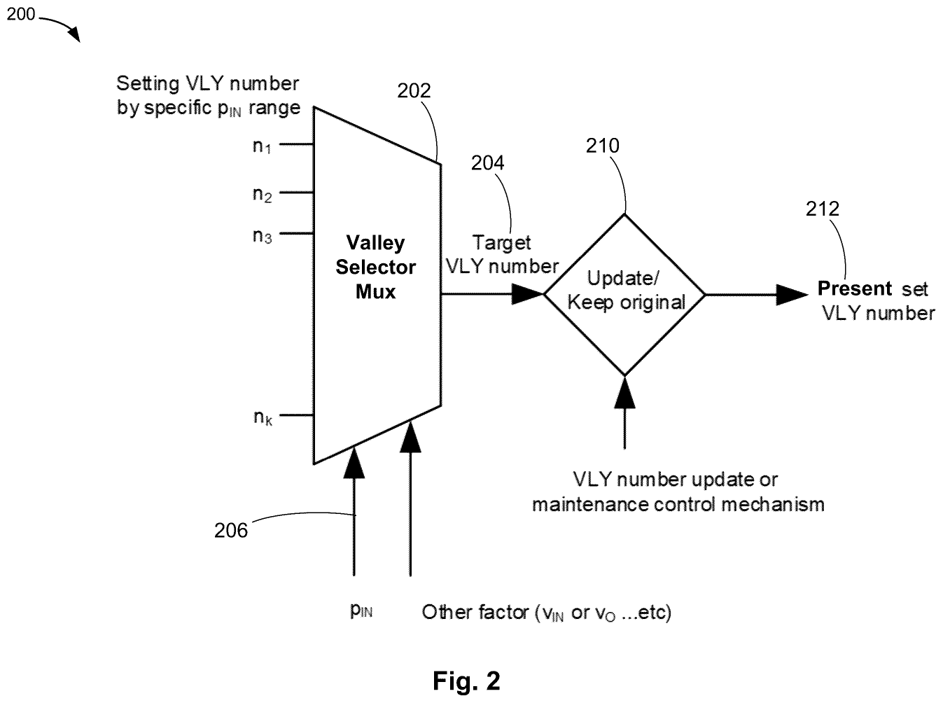

FIG. 2 illustrates a diagram of a valley lock number selection based on input power, according to some embodiments of the disclosure. As shown in FIG. 2, a valley selector multiplexor 202 may include several inputs and an output that can be arranged to generate an output target valley number 204. Inputs to the multiplexor can be the valley numbers that can be used, for example n₁, n₂, n₃, up to nₖ. The valley selector multiplexor 202 may also have a power input 206 (p_{IN}) that can receive the value of input power. Additional inputs to the multiplexor can includes factors such as, but not limited to, for example, input voltage (V_{IN}) and output voltage (v_{O}). The output of valley lock selector multiplexor can be a target valley number 204. A determination block 210 can be used to compare target valley number 204 to target valley number and determine whether to change the valley number or stay at the same switching valley number. The determination block 210 may receive an input from a valley update/maintain control circuit. The determination block 210 can determine whether to update the valley number or to keep the original valley number, and can then generate output for present set valley number 212.

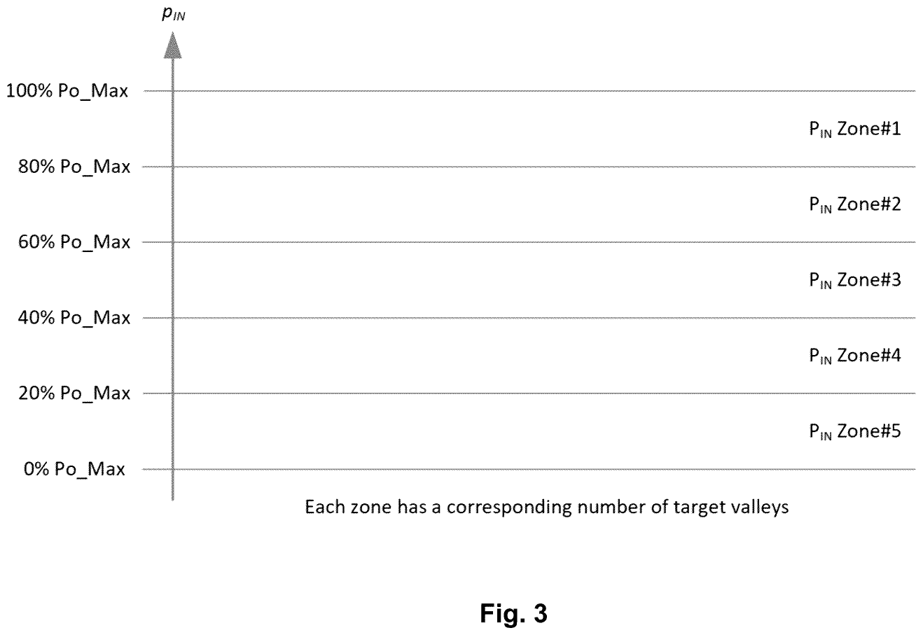

FIG. 3 illustrates an example of a valley selection method used to select a valley number for operating the switch 115, according to certain embodiments. An output power of a QR flyback converter can closely track an input power to that converter. FIG. 3 illustrates a chart for a QR flyback converter with an output full load of 100% Po_Max. The input power p_{IN} may be divided into 5 zones. Each zone has a corresponding number of target valleys. The chart illustrates that for various power outputs, a unique valley number can be determined. The illustrated example can select 5 zones and a fixed power zone range. In various embodiments, there is no limit to the scope and quantity of each power zone.

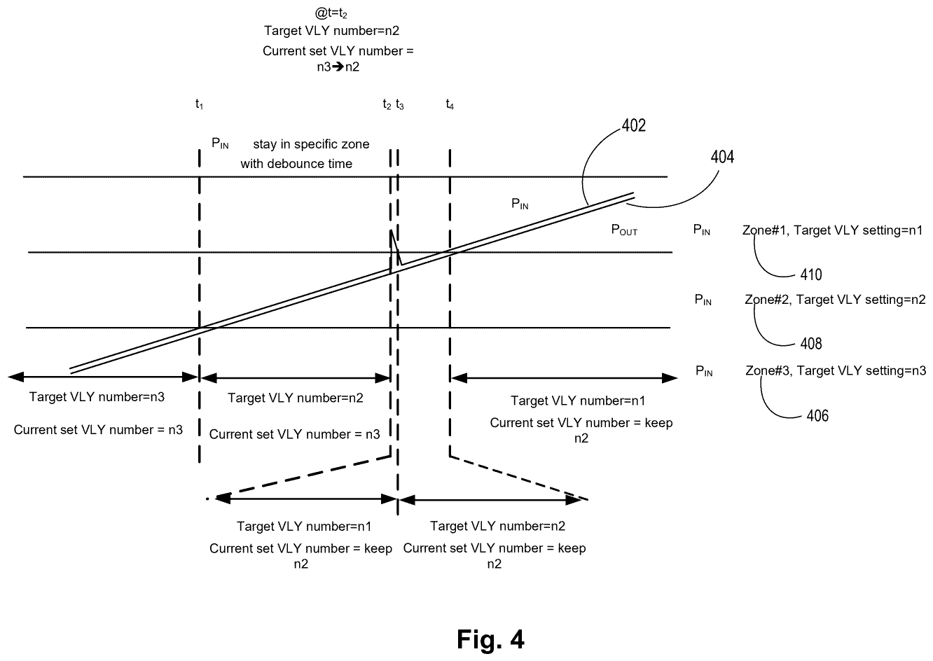

FIG. 4 illustrates a graph for determining the valley number, according to embodiments of the disclosure. As shown in FIG. 4, input power 402 and output power 404 are graphed as a function of time. As can be seen, input power and output power may track each other closely. When the input power is within the Zone #3 (406) range and the maintenance time exceeds the debounce time, the target valley number will be set to n₃, and the current number for the system may also be set is n₃ (t<t₁). When the input power changes from Zone #3 to Zone #2 (t=t₁), the input power may enter Zone #2 range, so the target trough number is set to n₂, however the maintenance time in Zone #2 has not exceeded the debounce time, so the present set valley of the system may be maintained at the previous setting value n₃ (t=t₁ to t₂). When the input power stays in Zone #2 for more than the debounce time, the present set valley number of the system can be updated and reset to the target valley number, n₂ (t=t₂).

Present set valley number represents the present number of valleys in the system. Present number may also be referred to as current number. Target valley number represents the number of valleys selected based on input power zone number. When t<t₁, output power pour may have value close to the input power pix in Zone #3. Thus, target valley number can be set equal to the current valley number, i.e., n=n₃. When t₁<t<t₂, output power (and input power) may enter zone #2, where the target valley number is n=n₂, however the power converter's valley number remains at n=n₃ because the calculated value of pix does not remain at Zone #2 with debounce time. During the time period between t₂ to t₃, when time is at t₂, the debounce time period may have completed. Therefore, the valley number can change from n=n₃ to n=n₂. At the same time, the input power may instantaneously change because the number of valleys is reduced. In some embodiments, a wait time for the system feedback response may be used to re-adjust on-time of the main switch (Ton) in order to maintain stable output. So long as a recovery time of this feedback response does not exceed the debounce time, the number of system valley can remain at n=n₂ (and not change to n₁). When t₃<t<t₄, the output power pour may have a value close to the input power pix in Zone #2. Thus, target valley number can be set equal to the current set valley number, i.e., n=n₂. When t₄<<t₅, input power pix may enter Zone #1 (410), so the target valley number can change to n=n₁. The debounce timer starts again, and the current set valley number can remain at n=n₂ until debounce time has been satisfied.

In some embodiments, a decision can be made for updating the valley number at each control cycle or PWM cycle. If the power is in a fixed zone for a period of time, the valley number can be updated for that zone. If the input power is varying between zones, then the original valley number is maintained at the current number. The valley number may remain in a zone for a predetermined period of time. In some embodiments, the predetermined period of time may be a debounce time. In various embodiments a debounce time of 1 ms may be used, however any other suitable debounce time is within the scope of this disclosure. If the input power is in a power zone for the predetermined period of time (e.g., the debounce time) the valley number will be updated to that power zone. In some embodiments, valley number updating method may include the input power (p_{IN}) staying in a fixed zone for a predetermined period of time, then the valley number getting changed to a new valley number. However, when the Pin does not stay in the fixed zone for the predetermined period of time, then the previous valley number is retained.

In various embodiments, an input power to the QR flyback converter may be continuously monitored by the primary side controller 150 and an operating resonant voltage valley may be selected based on the input power. As shown in FIG. 4, when the input power 402 of the QR flyback converter is within the Zone #3 (406) range and the maintenance time exceeds the debounce time, the target valley number can be set to n₃, and the current set trough number of the system can also be set to n₃ (t<t₁). When the input power changes from Zone #3 to Zone #2 (408) (t=t₁), the input power enters Zone #2 range, therefore the target trough number may be set to n₂, however the maintenance time in Zone #2 has not exceeded the debounce time, thus the present set valley of the system may be maintained at the previous setting value n₃ (t=t₁ to t₂). When the input power stays in Zone #2 for more than the debounce time, the present set valley number of the system may be updated and reset to the target valley number n₂ (t=t₂).

In some embodiments, when the switch 115 transitions from on-state to an off-state, a series of resonant voltage valleys may occur at the drain terminal. The controller circuit 150 can be arranged to determine an input power at the input terminal 107 and in response, and determine a resonant voltage valley number based at least in part on the input power, and transition the switch 115 from the first off-state to a second on-state when a sequential number of a series of resonant voltage valley numbers equals the resonant voltage valley number. The sequential number of a plurality of resonant voltage valley numbers is the number of the valley, e.g., 1, 2, 3, . . . , n. For example, valley number 3 can be selected based on the input power. Thus, the sequence number is 3 and the power converter can be operated using valley number 3. When the input power changes (and after a predetermine time has elapsed), the valley number can be changed to a different number, for example, 2, thus the sequence number is 2.

In some embodiments the selection of a valley can be determined based on an external resistor connected to the primary side controller 150. In some embodiments the controller locks the valley (e.g., uses the same valley number repeatedly) and may periodically change the valley lock based on input power. In this way, audible noise can be reduced because if the converter were to operate on a different valley with for each occurrence, the switching frequency may dither which can result in increased audible noise.

In various embodiments, the primary side controller 150 may be arranged to calculate the input power based on the input voltage and ins (current through the switch 115):

$$Power = V \cdot I$$

$${p}_{IN} = {v}_{IN} \cdot {i}_{IN} = {v}_{IN} \cdot 〈 {i}_{DS} 〉$$

$$〈 {i}_{DS} 〉 = \frac{{\int }_{0}^{{T}_{s}} {i}_{DS}}{{T}_{s}}$$

A method of calculating an average input power may be based on other calculation methods and are not limited to the above illustrated method. Other suitable methods may be used and are within the scope of this disclosure. In some embodiments, the average value of iDs can be determined based on techniques that may not use taking an average after integration. For example, any suitable value obtained by taking a middle point or a peak value for the pin calculation is within the scope of this disclosure. Various sampling techniques for sampling the input voltage and ins are within the scope of this disclosure.

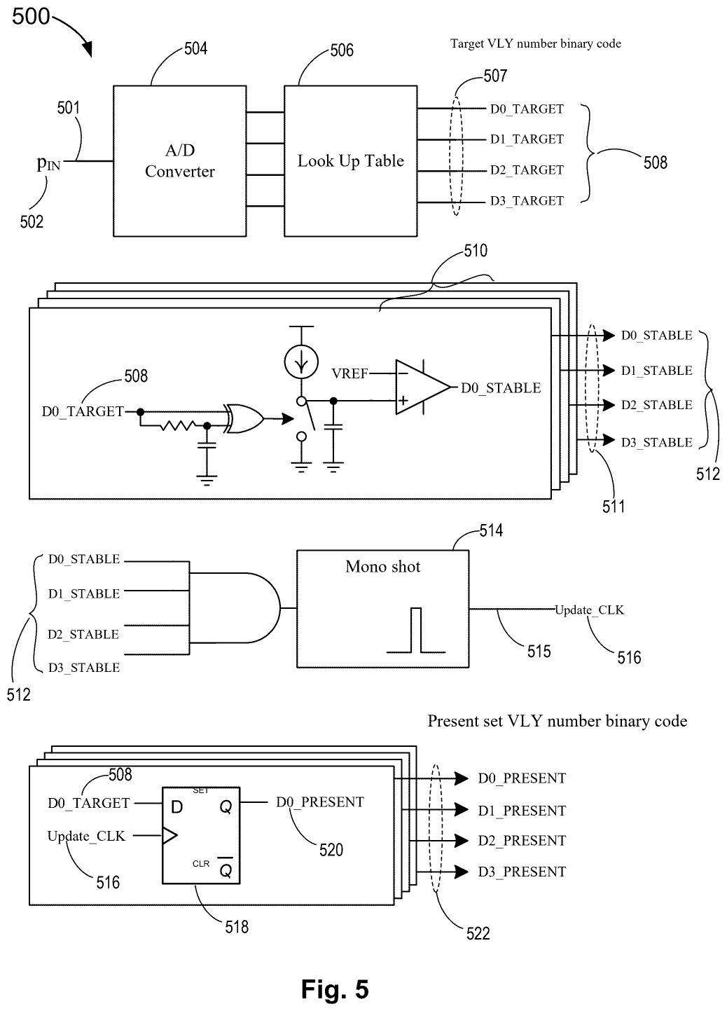

FIG. 5 illustrates a schematic of a valley number selection and determination circuit that can be used to change the valley number, according to certain embodiments. Circuit 500 can include an input terminal 501 connected to a A/D converter 504. The A/D converter 504 is connected to a look up table 506 having output terminal 507. Output terminal 507 can be connected to a circuit 510 having output terminal 511. Output terminal 511 can be connected to a mono shot circuit 514 having output terminal 515. When an average value of the input power pIN 502 is input to the A/D converter 504, a corresponding digital signal is generated according to the threshold value of pIN, and the digital signal is sent to the look-up table 506 to determine the target valley number corresponding to the current pIN (implemented in binary code, in some embodiments). The target valley number can be input to a circuit 510 that is arranged to generate D0_stable 512. When the target valley number binary code 508 maintains a stable state for a predetermined period of time (for example, 1 ms), an updated CLK signal 516 can be generated by the mono shot circuit 514 to update the current target valley number to the present set valley number 522. D0_Target 508 and update_CLK 516 can be input to a flip-flop 518 that is arranged to generate D0_present 520.

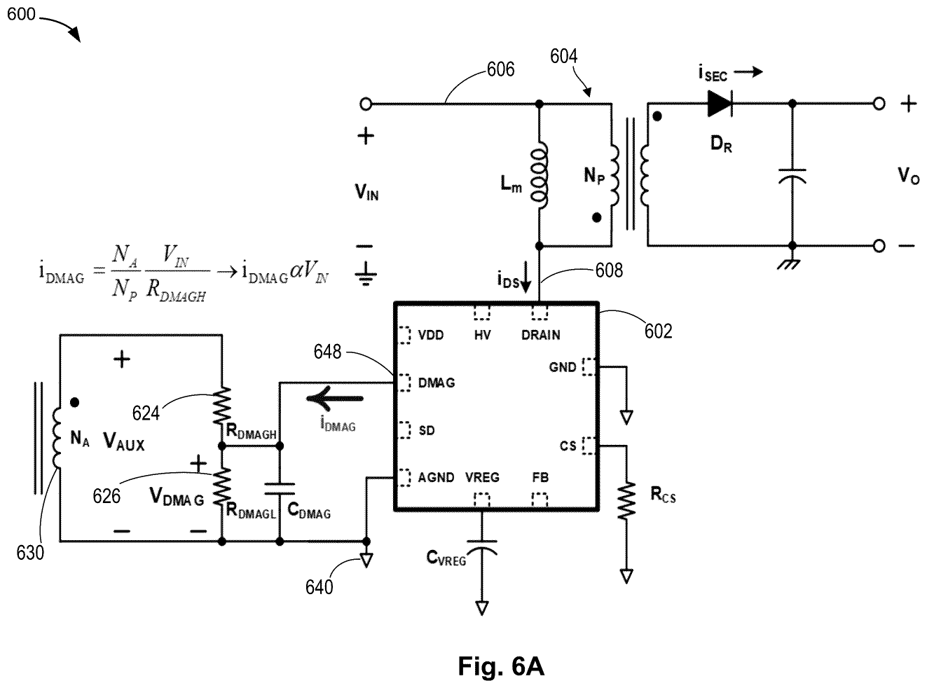

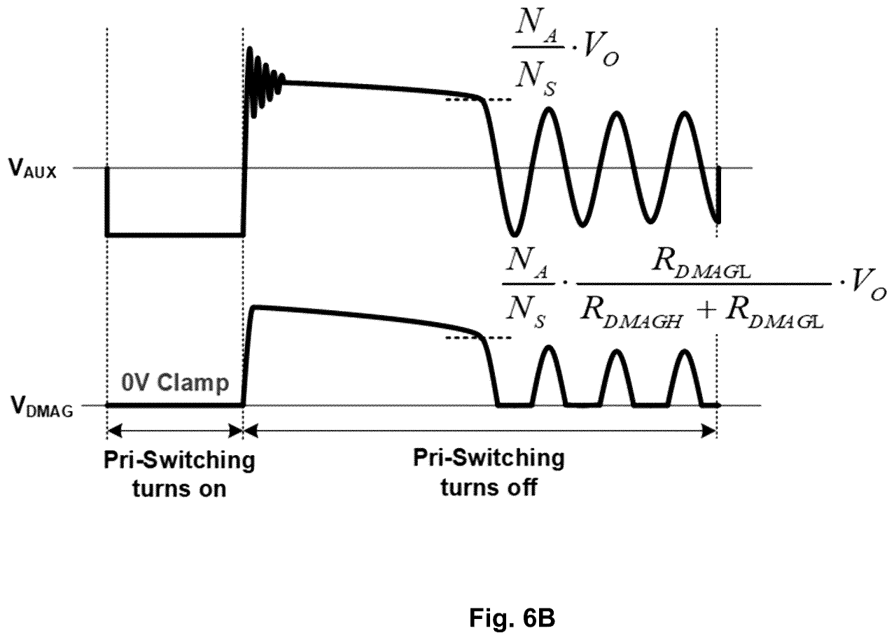

FIGS. 6A and 6B illustrates a power converter 600 with circuits arranged to determine input power using input voltage sensing, according to certain embodiments. FIG. 6A illustrates a controller circuit 602 that includes a primary side controller co-packaged along with a power switch. FIG. 6B illustrates auxiliary voltage Vaux and the voltage at DMAG pin 648. The primary side controller may be arranged to perform valley lock control as discussed above. The power switch can be silicon based, or GaN based, or silicon-carbide based. A primary winding 604 can have a first terminal 606 and a second terminal 608. The second terminal 608 can be connected to a drain pin of the controller circuit 602. The QR flyback converter circuit 600 can include a resistor 624 and a resistor 626 that are coupled between the auxiliary winding 630 to ground 640. During input signal on period, the primary winding 604 can be magnetically coupled to the auxiliary wining 630, thereby a voltage Vaux can be generated at the auxiliary winding 630, where Vaux is equal to Vin. Sourcing current on DMAG pin 648 may clamp to OV and i_{DMAG} may be proportional to Vin, thus the input power can be determined:

$${i}_{DMAG} = \frac{{N}_{A}}{{N}_{P}} \frac{{V}_{IN}}{{R}_{DMAGH}} \to {i}_{DMAG} α {V}_{IN}$$

In some embodiments, other methods for the input voltage detection can be utilized. These methods may use a package pin coupled to the input bulk capacitor to sense voltage or current. In various embodiments, iDMAG, through a resistor may be used, and a transformer coupled to bulk capacitor may be used, so that the input voltage can be detected. In some embodiments, a high voltage (HV) pin may be used along with integrated a resistor divider, where the resistor divider is connected to bulk capacitor to sense the input voltage.

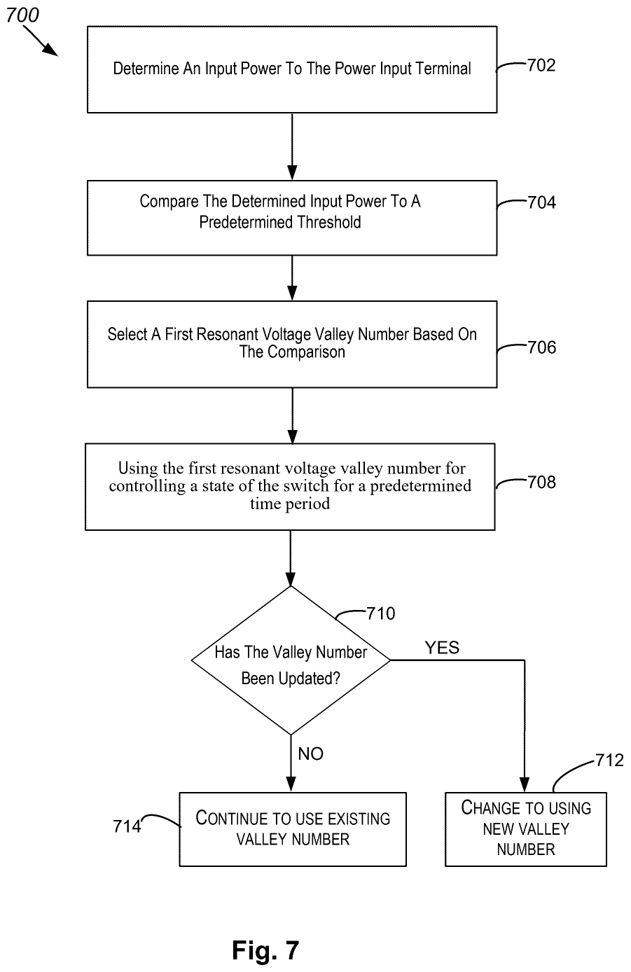

FIG. 7 is a simplified flowchart illustrating a method of determining valley number in a QR flyback converter based on primary side input power, according to some embodiments of the disclosure. Referring to FIG. 7, a method 700 for determining valley number in a QR flyback converter based on primary side input power can include determining an input power to the power input terminal (702). The method further includes comparing the determined input power to a predetermined threshold (704). The method also includes selecting a first resonant voltage valley number based on the comparison (706), and using the first resonant voltage valley number for controlling a state of the switch for a predetermined time period (708). The method additionally determining if the valley number has been updated based on the input power (710). If the valley number has been updated, the controller circuit can change the valley number to a new valley number (712), however if it has not been updated, the controller circuit can continue to use the existing valley number (714).

It should be appreciated that the specific steps illustrated in FIG. 7 provide a particular method of determining valley number in a QR flyback converter based on primary side input power according to an embodiment of the disclosure. Other sequences of steps may also be performed according to alternative embodiments. For example, alternative embodiments of the disclosure may perform the steps outlined above in a different order. Moreover, the individual steps illustrated in FIG. 7 may include multiple sub-steps that may be performed in various sequences as appropriate to the individual step. Furthermore, additional steps may be added or removed depending on the particular applications. One of ordinary skill in the art would recognize many variations, modifications, and alternatives.

In some embodiments, combination of the circuits and methods disclosed herein can be utilized to provide a valley number selection for operation of the flyback converter. Although circuits and methods are described and illustrated herein with respect to several particular configuration of the flyback converter, embodiments of the disclosure are suitable for QR flyback converter, asymmetric half bridge (AHB) and power factor correction circuit (PFC), or any power electronic conversion architecture with DCM operation.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the switch in use and/or operation in addition to the orientation depicted in the figures. For example, if the switch in the figures is turned over, elements described as a “bottom” surface can then be oriented “above” other elements or features. The switch can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A circuit comprising:
a transformer having a primary winding magnetically coupled to a secondary winding, the primary winding extending from a first terminal to a second terminal, the first terminal connected to a power source;
a switch having a gate terminal, a source terminal and a drain terminal, the drain terminal connected to the second terminal, the source terminal coupled to a ground; and
a controller circuit connected to the gate terminal and arranged to transition the switch from a first on-state to a first off-state, wherein in response to the transition a plurality of resonant voltage valleys occur at the drain terminal, the controller circuit further arranged to:
determine an input power at the first terminal and in response, and
determine a resonant voltage valley number based at least in part on the input power; and
transition the switch from the first off-state to a second on-state when a sequential number of a plurality of resonant voltage valley numbers equals the resonant voltage valley number.

2. The circuit of claim 1, wherein the transition from the first off-state to the second on-state is performed after a predetermined period of time.

3. The circuit of claim 2, wherein the resonant voltage valley number is a first resonant voltage valley number, the controller circuit further arranged to determine a second resonant voltage valley number and transition the switch to a third on-state based at least in part on the second resonant voltage valley number.

4. The circuit of claim 3, wherein the transition to the third on-state is performed after the predetermined period of time.

5. The circuit of claim 4, wherein the predetermined period of time has a value of zero.

6. The circuit of claim 5, wherein the controller circuit comprises a lookup table having a plurality of predetermined threshold values.

7. The circuit of claim 1, wherein determine the input power comprises sensing an input voltage at the first terminal, sensing a current flowing through the drain terminal to the source terminal and calculating the input power based on the sensed input voltage and the sensed current.

8. A power converter circuit comprising:
a solid state switch controlled by a control circuit, the control circuit arranged to transition the solid state switch from a first on-state to a first off-state, wherein in response to the transition a plurality of resonant voltage valleys occur at a drain terminal of the solid state switch, the control circuit further arranged to:
determine an input power to the power converter circuit and in response,
determine a resonant voltage valley number based at least in part on the input power; and
transition the solid state switch from the first off-state to a second on-state when a sequential number of the plurality of resonant voltage valleys equals the resonant voltage valley number.

9. The power converter circuit of claim 8, wherein the transition from the first off-state to the second on-state is performed after a predetermined time period.

10. The power converter circuit of claim 8, wherein the resonant voltage valley number is a first resonant voltage valley number, the control circuit further arranged to determine a second resonant voltage valley number and transition the solid state switch to a third on-state based at least in part on the second resonant voltage valley number.

11. The power converter circuit of claim 10, wherein the transition to the third on-state is performed after a predetermined time period.

12. The power converter circuit of claim 8, wherein determine the resonant voltage valley number comprises comparing the determined input power to a predetermined threshold value.

13. The power converter circuit of claim 12, wherein the control circuit comprises a lookup table having a plurality of predetermined threshold values.

14. The power converter circuit of claim 8, wherein determine the input power comprises sensing an input voltage to the power converter circuit, sensing a current flowing through the drain terminal to a source terminal of the solid state switch and calculating the input power based on the sensed input voltage and the sensed current.

15. A method of operating power converter circuit, the method comprising:
providing a solid state switch in the power converter circuit;
controlling the solid state switch, by a control circuit, to transition from a first on-state to a first off-state, wherein in response to the transition a plurality of resonant voltage valleys occur at a drain terminal of the solid state switch;
determining, by the control circuit, an input power to the power converter circuit;
determining a resonant voltage valley number, in response to determining the input power, based at least in part on the input power; and
transitioning, by the control circuit, the solid state switch from the first off-state to a second on-state when a sequential number of the plurality of resonant voltage valleys equals the resonant voltage valley number.

16. The method of claim 15, wherein the transition from the first off-state to the second on-state is performed after a predetermined time period.

17. The method of claim 15, wherein the resonant voltage valley number is a first resonant voltage valley number, and the method further comprises determining, by the control circuit, a second resonant voltage valley number and controlling the solid state switch to transition to a third on-state based at least in part on the second resonant voltage valley number.

18. The method of claim 15, wherein determining the resonant voltage valley number comprises comparing the determined input power to a predetermined threshold value.

19. The method of claim 18, wherein the control circuit comprises a lookup table having a plurality of predetermined threshold values.

20. The method of claim 15, wherein determining the input power comprises sensing an input voltage to the power converter circuit, sensing a current flowing through the drain terminal to a source terminal of the solid state switch and calculating the input power based on the sensed input voltage and the sensed current.
